(19) United States
(12) Patent Application Publication
(10) Pub. No.: US 2015/0277814 A1
(43) Pub. Date: Oct. 1, 2015

(54) IMAGE FORMING APPARATUS

(71) Applicant: KYOCERA Document Solutions Inc., Osaka (JP)

(72) Inventor: Yukihiro Shibata, Osaka (JP)

(21) Appl. No.: 14/671,713

(22) Filed: Mar. 27, 2015

(30) Foreign Application Priority Data
Mar. 31, 2014 (JP) 2014-073777

(51) Int. Cl. G06F 3/12

(52) U.S. Cl. CPC G06F 3/1221; G06F 3/1217; G06F 3/1231; G06F 3/1297

(57) ABSTRACT

An image forming apparatus includes a storage portion, a counting portion, an operation input portion, and a return portion. In storage portion, print data received from outside is stored. Counting portion counts an elapsed time period from a time of reception of the print data. Operation input portion receives an operation input for issuing a printing instruction for the print data stored in storage portion. Return portion compares a counted value obtained by counting portion with a first set time period set based on a printing standby time period from a time of reception of the print data until a time of inputting of the printing instruction via operation input portion, and cancels a power saving operation state of the image forming apparatus to cause the image forming apparatus to return to a normal operation state when the counted value has become the first set time period.

### INCORPORATION BY REFERENCE

This application is based upon and claims the benefit of priority from the corresponding Japanese Patent Application No. 2014-073777 filed on Mar. 31, 2014, the entire contents of which are incorporated herein by reference.

### BACKGROUND

The present disclosure relates to an image forming apparatus that performs, when a printing instruction is inputted thereto with respect to print data received from the outside, image forming based on the print data.

Conventionally, image forming apparatuses, such as copy machines, printers, and facsimile apparatuses, are controlled to operate in either one of operation modes of a normal operation mode and a power saving mode (also referred to as a sleep mode). The normal operation mode is an operation mode in which the image forming apparatus is on standby in an operation state (normal operation state) where the image forming apparatus can immediately perform image forming when a printing instruction is inputted. The power saving mode is an operation mode in which the image forming apparatus is on standby in a state (power saving operation state) where power consumption of the image forming apparatus is suppressed by supplying power only to a part of components. For example, in a case where a standby time period from power-on to input of a printing instruction is shorter than or equal to a set time period, the image forming apparatus operates in the normal operation mode. In a case where the standby time period is longer than the set time period, the normal operation mode is shifted to the power saving mode. In an image forming apparatus of this type, supply of power to a part of components is reduced or stopped in the power saving mode.

There is known an image forming apparatus that can select, in order to further enhance the power saving effect in the power saving mode, whether to return the image forming apparatus from the power saving mode to the normal operation mode, for each user who uses the image forming apparatus. There is also known an image forming apparatus that can determine, for each user, whether to allow supply of power to each functional portion.

### SUMMARY

An image forming apparatus according to one aspect of the present disclosure includes a storage portion, a counting portion, an operation input portion, and a return portion. In the storage portion, print data received from outside is stored. The counting portion counts an elapsed time period from a time of reception of the print data. The operation input portion receives an operation input for issuing a printing instruction for the print data stored in the storage portion. The return portion compares a counted value obtained by the counting portion with a first set time period set based on a printing standby time period from a time of reception of the print data until a time of inputting of the printing instruction via the operation input portion, and cancels a power saving operation state of the image forming apparatus to cause the image forming apparatus to return to a normal operation state when the counted value has become the first set time period.

This Summary is provided to introduce a selection of concepts in a simplified form that are further described below in the Detailed Description with reference where appropriate to the accompanying drawings. Furthermore, the claimed subject matter is not limited to implementations that solve any or all disadvantages noted in any part of this disclosure.

### BRIEF DESCRIPTION OF THE DRAWINGS

FIG. 1 is a network diagram showing a configuration of a printing processing system including an image forming apparatus according to an embodiment of the present disclosure.

FIG. 2 shows a configuration of the image forming apparatus included in the printing processing system shown in FIG. 1.

FIG. 3 is a block diagram showing a configuration of the image forming apparatus shown in FIG. 2.

FIG. 4 is a block diagram showing a configuration of a terminal device included in the printing processing system shown in FIG. 1.

FIG. 5 is a floor layout diagram for explaining positional relationship between the image forming apparatus and terminal devices included in the printing processing system shown in FIG. 1.

FIG. 6 is a flow chart showing one example of a procedure of a pull printing output process to be executed by a control portion of the image forming apparatus shown in FIG. 3.

FIG. 7 is a flow chart showing one example of a procedure of a set time period updating process to be executed by the control portion of the image forming apparatus shown in FIG. 3.

### DETAILED DESCRIPTION

Hereinafter, an embodiment of the present disclosure will be described with reference to the drawings. The embodiment below merely represents an exemplary implementation of the present disclosure, and does not limit the technical scope of the present disclosure.

[Image Forming Apparatus 42]

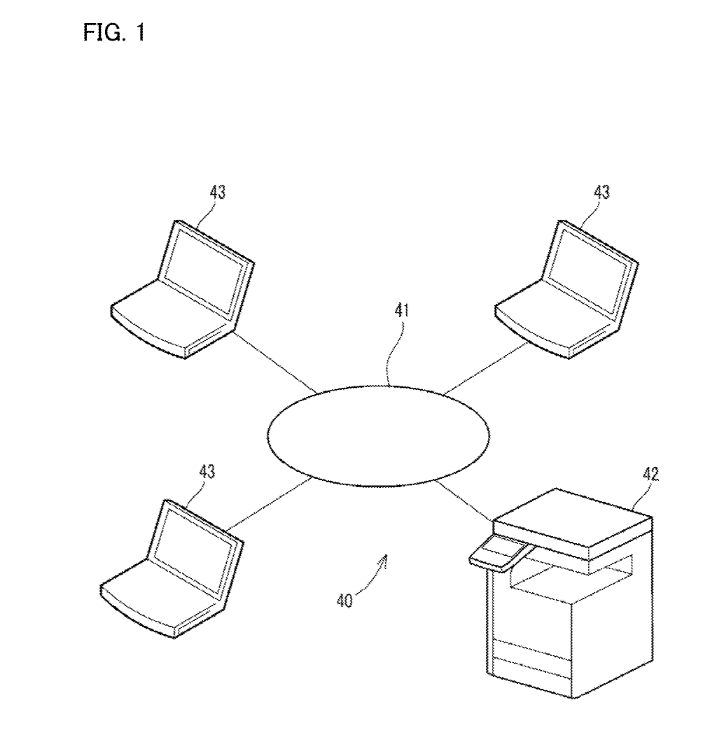

As shown in FIG. 1, a printing processing system 40 includes an image forming apparatus 42 and a plurality of terminal devices 43. The image forming apparatus 42 is one example of an image forming apparatus of the present disclosure. These devices are connected so as to be data-communicable with each other via a communication network 41 such as a LAN or a WAN that complies with IEEE 802.3 standard. Hereinafter, the configurations of the image forming apparatus 42 and the terminal devices 43 will be described in detail.

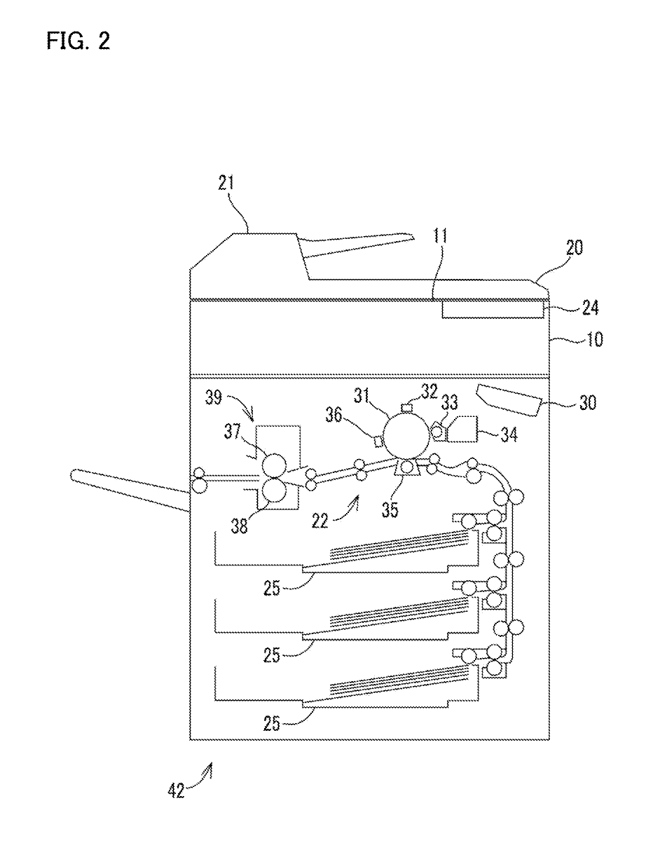

As shown in FIG. 2, the image forming apparatus 42 is a printer capable of forming an image on a print sheet. The image forming apparatus 42 prints print data inputted from a terminal device 43 onto a print sheet by using a print material such as a toner. The image forming apparatus 42 is not limited to a printer, and may be a multifunction peripheral that has at least a printing function.

The image forming apparatus 42 includes an image reading portion 10, a document sheet cover 20, an ADF (Auto Document Feeder) 21, sheet feed portions 25, an image forming portion 22, a fixing device 39, an operation display portion 24, and the like.

The image reading portion 10 includes the ADF 21. The image reading portion 10 reads an image of a document sheet set on the ADF 21 or on a contact glass 11, to obtain image data. The image reading portion 10 includes: imaging elements such as, for example, a CCD (Charge Coupled Device) or a CIS (Contact Image Sensor); an optical lens; a light source; and the like. In the image reading portion 10, light emitted from the light source onto a document sheet and reflected by the document sheet passes through the optical lens to be inputted to the imaging elements, whereby image data of the document sheet is read. Detailed description of the image reading portion 10 is omitted.

Each sheet feed portion 25 feeds a print sheet on which an image is to be formed in the image forming portion 22. The sheet feed portion 25 holds a plurality of print sheets in the form of a stack. The sheet feed portion 25 takes out the uppermost print sheet from these print sheets, one by one, and feeds the print sheet to the image forming portion 22.

The image forming portion 22 forms an image by electrophotography. The image forming portion 22 forms an image on a print sheet based on print data inputted from a terminal device 43 such as a personal computer connected to the communication network 41. Specifically, the image forming portion 22 includes a photosensitive drum 31, a charging device 32, a developing device 33, a toner container 34, a transfer roller 35, an electricity removing device 36, an LSU (laser scanning unit) 30, and the like. In the present embodiment, the image forming portion 22 employing electrophotography will be described as an example. However, the image forming portion 22 is not limited to an image forming portion of the electrophotography type, but may be of another image forming type.

In the image forming portion 22, image forming (printing) on a print sheet fed from the sheet feed portion 25 is performed in the following procedure. First, when a printing instruction is inputted to the image forming apparatus 42, the photosensitive drum 31 is uniformly charged at a predetermined potential by the charging device 32. Next, light based on image data included in the print data is applied to the surface of the photosensitive drum 31 by the LSU 30. Thus, an electrostatic latent image is formed on the surface of the photosensitive drum 31. The electrostatic latent image on the photosensitive drum 31 is developed (visualized) into a toner image by the developing device 33. Toner (developer) is additionally supplied to the developing device 33 from the toner container 34. Subsequently, the toner image formed on the photosensitive drum 31 is transferred to the print sheet by the transfer roller 35. Thereafter, the toner image having been transferred to the print sheet is heated and fused, to be fixed on the print sheet when the print sheet passes through the fixing device 39. Potential of the photosensitive drum 31 is removed by the electricity removing device 36.

The fixing device 39 includes a heating roller 37 rotatably supported by a frame (not shown), and a pressure roller 38 which is brought into pressure contact with and driven to rotate by the heating roller 37. Inside the heating roller 37, a heating device 37A is provided. The heating device 37A is one example of a heating portion of the present disclosure. The heating device 37A is implemented by a halogen heater or the like, and supplies heat from inside to the heating roller 37, thereby to heat the heating roller 37. In the present embodiment, the heating device 37A provided inside the heating roller 37 is described as an example, but an heating device of an induction heating type or the like that is disposed outside the heating roller 37 may be used.

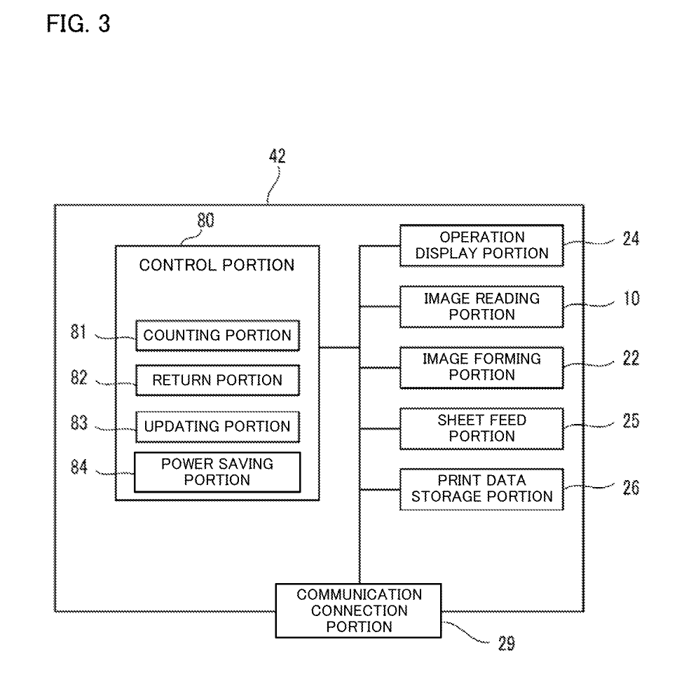

In the fixing device 39, in order to fuse the toner, the heating roller 37 is heated by the heating device 37A. In the present embodiment, heat applied by the heating device 37A is controlled by a control portion 80 (see FIG. 3) such that the surface temperature of the heating roller 37 becomes a set temperature (for example, 175° C.) which has been set in advance. In more detail, the heating roller 37 is heated by the heating device 37A such that the temperature of a nip portion between the heating roller 37 and the pressure roller 38 becomes the set temperature. By the nip portion being kept at the set temperature, the print sheet passing through the nip portion is heated to a temperature equivalent to the set temperature.

The operation display portion 24 is one example of an operation input portion of the present disclosure. The operation display portion 24 includes various types of operation keys, a liquid crystal display, and the like. As the operation keys, for example, a start button for inputting a printing instruction for print data stored in a print data storage portion 26 (see FIG. 3) of the image forming apparatus 42, a stop button for suspending printing, a numerical keypad, a cross key pad, and the like are arranged. By the start button being pressed, the operation display portion 24 receives an operation input for issuing a printing instruction. In the image forming apparatus 42, in accordance with a printing instruction which is inputted via the operation display portion 24 by the operation display portion 24 being operated, printing is executed based on print data which is stored in advance in the print data storage portion 26. When a user operates one of the operation keys in order to cause image forming (printing) in the image forming portion 22 to be executed, a contact signal of the operation key is outputted as an operation input signal, from the operation display portion 24 to the control portion 80 (see FIG. 3).

As shown in FIG. 3, the image forming apparatus 42 includes the control portion 80, the print data storage portion 26, and a communication connection portion 29.

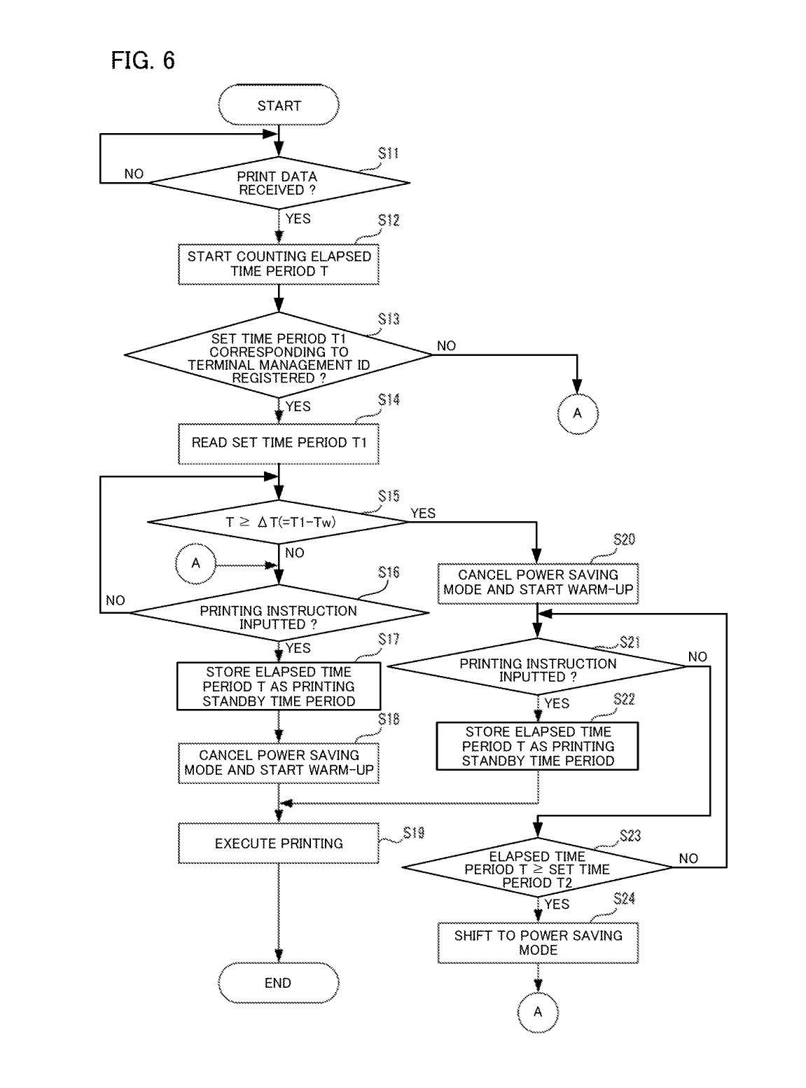

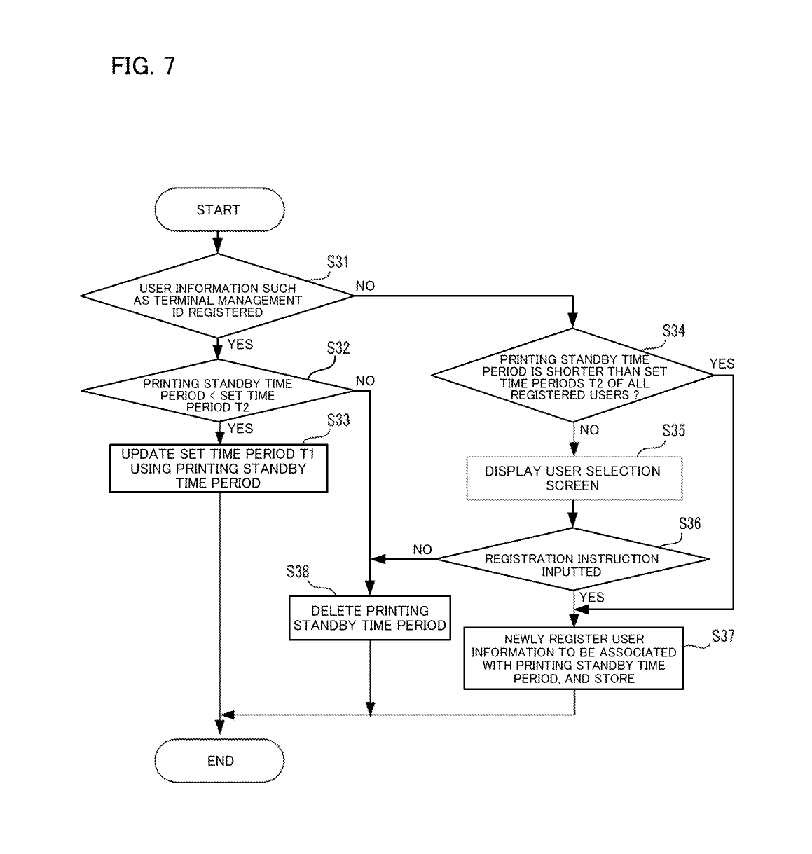

The control portion 80 performs comprehensive control over the image forming apparatus 42. Specifically, the control portion 80 controls image forming (printing) in the image forming portion 22. In the present embodiment, the control portion 80 executes a print-out process (hereinafter, referred to as pull printing output process) employing pull printing described later, in accordance with the flow chart shown in FIG. 6. In addition, the control portion 80 executes a set time period updating process described later, in accordance with the flow chart shown in FIG. 7.

The control portion 80 includes a CPU, a ROM, a RAM, an EEPROM (registered trademark), and the like, which are connected to each other via an internal bus. The CPU executes various types of control programs for controlling the image forming apparatus 42, and performs calculations in data processing. The control programs are stored in the ROM. By the control programs being executed by the CPU, the pull printing output process (see FIG. 6) and the set time period updating process (see FIG. 7) in the image forming apparatus 42 are executed. The RAM temporarily stores therein print data read from the print data storage portion 26, and data inputted from the communication connection portion 29. The data stored in the RAM is processed by the CPU, and the processed data is transferred to the image forming portion 22 as necessary.

The EEPROM stores therein various types of set information in the image forming apparatus 42. For example, sheet information about the type, the size, and the like of recording sheets contained in the sheet feed portion 25 is stored in the EEPROM. The sheet information is set based on: information inputted by a user via the operation display portion 24; a result of detection by a sheet size sensor that detects the sheet size; and the like.

In the EEPROM, device management data is stored which is obtained by converting information about all terminal devices 43 connected to the communication network 41 into data base. Various types of information such as terminal management IDs of the terminal devices 43 connected to the communication network 41, user IDs registered as users of the terminal devices 43, and installation positions of the terminal devices 43 is registered and managed in the device management data. Since the device management data is stored in the EEPROM in this manner, the control portion 80 can grasp, from the terminal management ID included in print data inputted to the communication connection portion 29, information such as the terminal device 43, its user, and its installation position. It should be noted that each terminal management ID and each user ID are examples of identification information of the present disclosure.

In the device management data, a set time period T1 is registered for each terminal management ID. The set time period T1 is a time period for determining a timing at which, when pull printing print-out (hereinafter, referred to as pull printing output) is performed from a terminal device 43 to the image forming apparatus 42, the operation mode of the image forming apparatus 42 is returned from a power saving mode described later to a normal operation mode described later. When the set time period T1 has elapsed after print data to be used in the pull printing output having been inputted to the communication connection portion 29, the power saving mode is canceled and the image forming apparatus 42 is caused to return to the normal operation mode. The set time period T1 is one example of a first set time period of the present disclosure. Specifically, the set time period T1 is a time period obtained by subtracting a return time period Tw described later from the average time period of printing standby time periods described later which correspond to a plurality of pull printing outputs. The printing standby time period is a time period required, in a case where a printing instruction has been issued for print data stored in the print data storage portion 26 as a result of a pull printing output executed in the past, from when the print data corresponding to this printing instruction has been inputted to the communication connection portion 29 until the printing instruction is inputted. The average time period is the average value of a plurality of printing standby time periods that correspond to a plurality of pull printing outputs executed in the past. The return time period Tw is a time period required from when a cancellation condition for the power saving mode has been satisfied until the image forming apparatus 42 actually returns to the normal operation state where the image forming apparatus 42 can perform image forming. The set time period T1 is used in the pull printing output process (see FIG. 6) described later. The set time period T1 is an update target in the set time period updating process (see FIG. 7) described later.

The pull printing is a type of printing in which: in a case where print data has been sent from a terminal device 43 to the image forming apparatus 42, the image forming apparatus 42 does not immediately perform output processing on the print data but temporarily stores the print data in the print data storage portion 26; and then, by the user directly performing an operation input for issuing a printing instruction onto the image forming apparatus 42, the image forming apparatus 42 reads the print data in the print data storage portion 26 and prints the print data.

It should be noted that the control portion 80 may be implemented by an electronic circuit or an integrated circuit such as ASIC or DSP.

In the present embodiment, the control portion 80 performs control of switching the operation mode of the image forming apparatus 42 to either one of the normal operation mode and the power saving mode (sleep mode). The normal operation mode is an operation mode in which printing in the image forming apparatus 42 can be immediately executed in a case where a printing instruction is inputted. Specifically, the control portion 80 performs heat control on the heating device 37A of the fixing device 39 so as to realize a predetermined fixing temperature at which the heating roller 37 can fix toner. The power saving mode is an operation mode in which the amount of heat generated by the heating device 37A of the fixing device 39 is suppressed in a case where no printing instruction is inputted within a certain time period. Specifically, the power saving mode is an operation mode in which heat control is performed on the heating device 37A or heating by the heating device 37A of the fixing device 39 is stopped so as to make the temperature of the heating roller 37 lower than the fixing temperature. It should be noted that switching of the operation mode in the image forming apparatus 42 and the respective operation modes are well known, and thus, detailed description thereof is omitted in the present embodiment.

In the present embodiment, the control portion 80 functions as a counting portion 81, a return portion 82, an updating portion 83, and a power saving portion 84, by the control programs in the ROM being executed by the CPU.

The counting portion 81 is a so-called software counter configured by a program. The counting portion 81 counts an elapsed time period T from the time of reception of print data from the communication connection portion 29. Instead of the counting portion 81, an electronic circuit or a counter configured as a device may be used.

The return portion 82 compares a counted value obtained by the counting portion 81 with the set time period T1 set based on printing standby time periods, each printing standby time period being from the time of reception of print data until the time of inputting of a printing instruction via the operation display portion 24. Then, when the counted value becomes the set time period T1, the power saving mode of the image forming apparatus 42 is canceled, and the image forming apparatus 42 is caused to return to the normal operation mode.

Moreover, when a printing instruction for print data has been inputted via the operation display portion 24 before the counted value reaches the set time period T1, the return portion 82 cancels the power saving mode and returns the image forming apparatus 42 to the normal operation mode.

The updating portion 83 updates the set time period T1 based on a printing standby time period corresponding to a printing instruction for print data which is the target of a newly received pull printing output. That is, when a pull printing output is newly performed and a printing standby time period therefor is obtained at that time, the set time period T1 is updated by use of printing standby time periods in the past including this printing standby time period. Specifically, the set time period T1 is changed to the average value of past printing standby time periods including the newly obtained printing standby time period.

When the counted value obtained by the counting portion 81 has become a set time period T2 which is longer than the set time period T1, the power saving portion 84 shifts the normal operation mode of the image forming apparatus 42 to the power saving mode. The set time period T2 is one example of a second set time period of the present disclosure. Specifically, the set time period T2 is a value obtained by multiplying the set time period by a previously defined coefficient. The coefficient is stored as variable information in the EEPROM of the control portion 80. The user can change the set value of the coefficient, by operating the operation display portion 24, reading the coefficient from the EEPROM, and changing the value through a key operation.

The print data storage portion 26 is one example of a storage portion of the present disclosure. The print data storage portion 26 temporarily stores therein print data which has been inputted from the communication connection portion 29 and which is to be used in the pull printing output process. That is, when print data to be used in the pull printing output process has been inputted to the communication connection portion 29, the control portion 80 does not immediately perform printing process on the print data, but stores the print data in the print data storage portion 26. The print data storage portion 26 is an HDD, for example.

The communication connection portion 29 is a communication interface which realizes transmission/reception of data with terminal devices 43 connected thereto via the communication network 41. The communication connection portion 29 is an NIC (Network Interface Card), for example.

[Terminal Device 43]

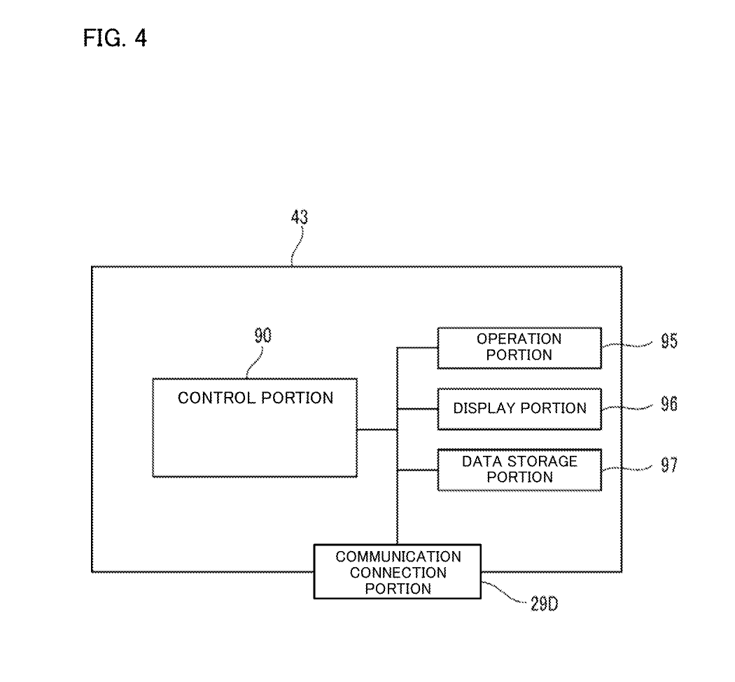

Each terminal device 43 is an information processing device, such as a personal computer, which causes the image forming apparatus 42 connected to the communication network 41 to execute the printing process. Specifically, the terminal device 43 performs print-out based on pull printing with regard to the image forming apparatus 42 which is connected to the communication network 41. As shown in FIG. 4, the terminal device 43 includes a control portion 90, an operation portion 95, a display portion 96, and a data storage portion 97.

The operation portion 95 is implemented by buttons, switches, and the like for making various types of setting and instructions. The operation portion 95 is a keyboard, for example. The display portion 96 is a monitor such as a liquid crystal panel, and displays screens to be used in various types of applications, inputted information, and the like. The data storage portion 97 is an HDD, for example. In the data storage portion 97, an operating system and various types of applications are stored. A communication connection portion 29D is a communication interface which realizes transmission/reception of data with the image forming apparatus 42 which is connected thereto via the communication network 41. The communication connection portion 29D is an NIC, for example.

The control portion 90 performs comprehensive control over the terminal device 43. The control portion 90 includes a CPU, a ROM, a RAM, an EEPROM, and the like. The CPU executes various types of applications to be realized on the terminal device 43, a printer driver for performing print-out of a document and the like created by use of applications, and the like. The applications and the printer driver are stored in the data storage portion 97. Each document created by such applications is converted by the printer driver into print data in a page description language (PDL) such as PCL, to be transmitted to the image forming apparatus 42 via the communication connection portion 29D.

[Positional Relationship Between Image Forming Apparatus 42 and Terminal Device 43]

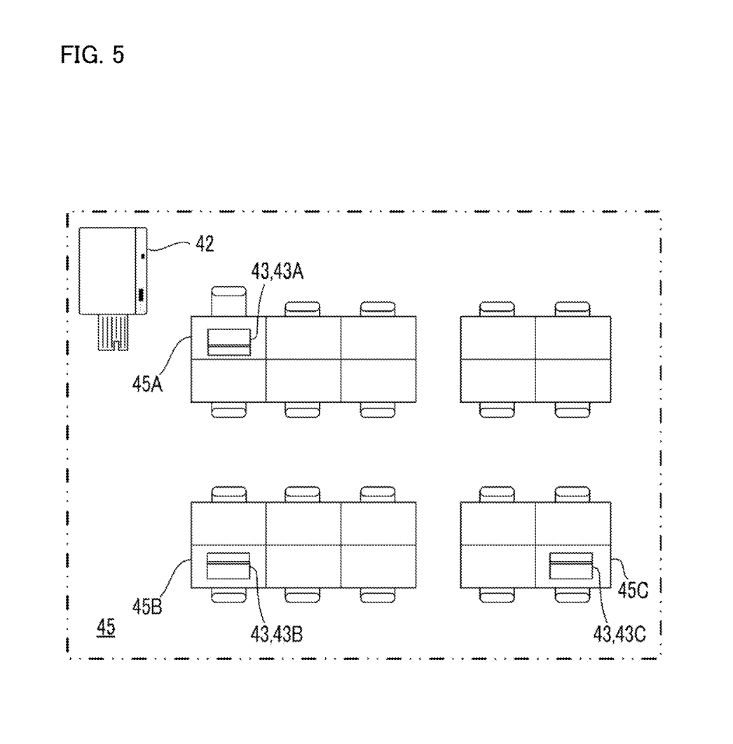

Next, positional relationship between the image forming apparatus 42 and the terminal device 43 will be described. In general, the printing processing system 40 is used in an office. For example, as shown in the layout diagram in FIG. 5, in a case where one image forming apparatus 42 is installed in a work room 45, among three terminal devices 43 (43A to 43C) that can use the image forming apparatus 42, the terminal device 43A is disposed at a desk 45A which is closest to the image forming apparatus 42. The terminal device 43B is disposed at a desk 45B which is second closest to the image forming apparatus 42. The terminal device 43C is disposed at a desk 45C which is farthest from the image forming apparatus 42. In such positional relationship, between a case where the user of the terminal device 43A performs a pull printing output, and a case where the user of the terminal device 43C performs a pull printing output, printing standby time periods are different from each other.

Meanwhile, in a case where printing is performed by pull printing described above, when print data is inputted from the terminal device 43 while the image forming apparatus 42 is in the power saving mode, there are cases where control of cancelling the power saving mode is performed at the timing of the inputting of the print data. In a case where the power saving mode is cancelled at the timing of the inputting of the print data, the image forming apparatus 42 returns to the normal operation mode before the user directly inputs a printing instruction to the image forming apparatus 42, and thus, surplus power is consumed by the amount corresponding to the early return of the image forming apparatus 42.

There are also cases where control of cancelling the power saving mode is performed at the timing when a predetermined time period has elapsed after print data having been inputted. However, in the case where the power saving mode is cancelled when the predetermined time period has elapsed, the image forming apparatus 42 may not have yet returned to the normal operation mode depending on the predetermined time period. In such a case, the user has to wait near the image forming apparatus 42 until the image forming apparatus 42 returns to the normal operation mode, which causes wasteful waiting time period. The problems of such surplus power consumption and the user's waiting time period could notably occur in cases where the devices are disposed in the positional relationship described above.

In the present embodiment, even in a case where the devices are disposed in the positional relationship described above, by the pull printing output process (see FIG. 6) described later being performed, it is possible to cause the image forming apparatus 42 to return to the normal operation state at the timing when the user inputs a printing instruction. Accordingly, the user's waiting time period can be reduced, and high power saving effect can be exhibited.

[Pull Printing Output Process]

Hereinafter, with reference to the flow chart in FIG. 6, one example of the procedure of the pull printing output process to be executed by the control portion 80 in the image forming apparatus 42 will be described. S11, S12, and the like in FIG. 6 each represent the number of the process procedure (step). In the following, for convenience of description, it is assumed that print data which becomes the output target of the pull printing output process has been outputted from the terminal device 43 to the image forming apparatus 42. In addition, it is assumed that the image forming apparatus 42 is operating in the power saving mode.

If the print data being the target of the pull printing output is received in the image forming apparatus 42 from the terminal device 43 (S11), the control portion 80 temporarily stores the print data in the print data storage portion 26. Then, in step S12, the control portion 80 starts counting the elapsed time period T from when the print data has been received. The control portion 80 performing the counting in step S12 is one example of a counting portion of the present disclosure.

Next, the control portion 80 reads a terminal management ID being the identification information of the terminal device 43 and included in the print data, and determines whether the terminal management ID has been registered in the device management data. Then, when the terminal management ID has been registered, the control portion 80 determines whether a set time period T1 corresponding to that terminal management ID has been registered (S13). If the set time period T1 has been registered, the process is advanced to step S14, and the set time period T1 is read from the EEPROM where the device management data is stored (S14). On the other hand, if the set time period T1 has not been registered, the control portion 80 advances the process to step S16, and in step S16, stands by until a printing instruction is directly issued through an operation input via the operation display portion 24 by the user.

When the set time period T1 has been read, then, in step S15, the control portion 80 determines whether the elapsed time period T is longer than or equal to a time difference ΔT. Here, the time difference ΔT is a time difference obtained by subtracting a return time period Tw from the set time period T1. If the elapsed time period T is longer than or equal to the time difference ΔT, the process is advanced to step S20. On the other hand, if the elapsed time period T is shorter than the time difference ΔT, the process is advanced to step S16.

In step S16, the control portion 80 determines whether a printing instruction has been directly issued through an operation input via the operation display portion 24 by the user. In step S16, if the printing instruction has been inputted, the control portion 80 temporarily stores the elapsed time period T, as the printing standby time period, into the RAM of the control portion 80 (S17). Thereafter, the control portion 80 cancels the power saving mode of the image forming apparatus 42 to be shifted to the normal operation mode. This starts warm-up of the heating roller 37 having been controlled at a low temperature in the power saving mode (S18). That is, the control portion 80 causes the heating device 37A to be heated to the fixing temperature. Thereafter, when the heating device 37A is heated to the fixing temperature, the control portion 80 executes image forming (printing) based on the print data stored in the print data storage portion 26 (S19).

On the other hand, in step S15, if it has been determined that the elapsed time period T is longer than or equal to the time difference ΔT, then, in the next step S20, without waiting for an input of a printing instruction, warm-up of the heating roller 37 is started as in step S18. It should be noted that the control portion 80 executing the process of step S15 and step S20 is one example of a return portion of the present disclosure. Then, in step S21, if the printing instruction has been inputted, the control portion 80 temporarily stores the elapsed time period T, as the printing standby time period, into the RAM of the control portion 80 (S22). Thereafter, when the heating roller 37 is heated to the fixing temperature, the control portion 80 executes image forming (printing) based on the print data stored in the print data storage portion 26 (S19).

In step S21, if no printing instruction has been inputted, the control portion 80 determines whether the elapsed time period T is longer than or equal to a set time period T2 (S23). Then, on a condition that the elapsed time period T has become longer than or equal to the set time period T2, the control portion 80 causes the image forming apparatus 42 having been in the normal operation mode to operate in the power saving mode again (S24). Then, the control portion 80 advances the process to step S16, and in step S16, stands by until a printing instruction is directly issued through an operation input via the operation display portion 24 by the user. It should be noted that the control portion 80 performing the process of step S23 and step S24 is one example of a power saving portion of the present disclosure.

As described above, by the control portion 80 executing the pull printing output process, the power saving mode is canceled before a printing instruction is inputted, and warm-up of the heating roller 37 is started (S15, S20). Thus, warm-up of the heating roller 37 is completed at the timing when the set time period T1 has elapsed, and at the timing of the completion, the user arrives at the image forming apparatus 42 and immediately inputs a printing instruction, thereby being able to execute the pull printing output. As a result, it is possible to suppress wasteful power consumption, without starting warm-up of the heating roller 37 too early. Furthermore, the user need not stand by near the image forming apparatus 42 while wasting time, and can obtain the printed article efficiently in terms of time.

According to the embodiment described above, in step S13 and step S14, the set time period T1 corresponding to the terminal management ID is read. However, in a case where the user ID indicating the user of the terminal device 43 is included in the print data, the control portion 80 may determine whether the set time period T1 corresponding to that user ID has been registered, and in a case where such set time period T1 has been registered, the control portion 80 may read the set time period T1 corresponding to that user ID from the EEPROM.

[Set Time Period Updating Process]

Hereinafter, with reference to the flow chart shown in FIG. 7, one example of the procedure of the set time period updating process to be executed by the control portion 80 in the image forming apparatus 42 will be described. This set time period updating process is a process of updating the set time period T1. S31, S32, and the like in FIG. 7 each represent the number of the process procedure (step). In the following, for convenience of description, it is assumed that the pull printing output process has ended and the printing standby time period has been stored in the RAM of the control portion 80.

First, in step S31, the control portion 80 determines whether identification information (user information) such as a terminal management ID or a user ID included in the print data in the pull printing output has been registered in the device management data. In a case where the identification information has been registered, then, in the next step S32, the control portion 80 determines whether the printing standby time period stored in the RAM is shorter than the set time period T2. If the printing standby time period is shorter than the set time period T2, the control portion 80 updates the set time period T1 by use of the printing standby time period (S33). Specifically, the control portion 80 uses a new printing standby time period obtained through the pull printing process described above, and past printing standby time periods used in calculation of the set time period T1, to newly calculate an average value of printing standby time periods, and changes the set time period T1 to the calculated average value. It should be noted that the control portion 80 executing the process of step S33 is one example of an updating portion of the present disclosure.

On the other hand, in step S32, if the printing standby time period is longer than or equal to the set time period T2, the control portion 80 deletes the printing standby time period stored in the RAM (S38), and ends the process without updating the set time period T1.

In step S31, if identification information (user information) such as a terminal management ID or a user ID has not been registered in the device management data, then, in the next step S34, the control portion 80 determines whether the printing standby time period is shorter than all the set time periods T2 corresponding to all identification information registered in the device management data. If it has been determined that the printing standby time period is shorter than all the set time periods T2, it is determined that the printing standby time period and the terminal management ID are a target to be registered in the device management data, and the printing standby time period is newly registered in the device management data along with the terminal management ID or the user ID (S37). On the other hand, if the printing standby time period is longer than or equal to any of the set time periods T2, a screen which allows the user to select whether to perform registration is displayed on the operation display portion 24 (S35). Then, only in a case where a registration instruction has been inputted by the user via the operation display portion 24, the printing standby time period is newly registered in the device management data along with the terminal management ID or the user ID (S37). In a case where an instruction not to perform registration has been inputted, the control portion 80 deletes the printing standby time period stored in the RAM (S38), and ends the process without updating the set time period T1.

As described above, since the set time period T1 is updated in step S33, even if the printing standby time period varies, the printing standby time period is updated to a set time period T1 corresponding to such change. As a result, wasteful power consumption and wasteful waiting time period are reduced. In addition, in a case where the printing standby time period is longer than or equal to any of the set time periods T2, the set time period T1 is not updated. Accordingly, it is possible to prevent a large change of the set time period T1 which could be caused by updating the set time period T1 by use of a long printing standby time period.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
a storage portion configured to store therein print data received from outside;
a counting portion configured to count an elapsed time period from a time of reception of the print data;
an operation input portion configured to receive an operation input for issuing a printing instruction for the print data stored in the storage portion; and
a return portion configured to compare a counted value obtained by the counting portion with a first set time period set based on a printing standby time period from a time of reception of the print data until a time of inputting of the printing instruction via the operation input portion, and configured to cancel a power saving operation state of the image forming apparatus to cause the image forming apparatus to return to a normal operation state when the counted value has become the first set time period.

2. The image forming apparatus according to claim 1, wherein
the first set time period is a time period obtained by subtracting a return time period required for the returning caused by the return portion, from an average time period of a plurality of the printing standby time periods corresponding to a plurality of the printing instructions.

3. The image forming apparatus according to claim 1, further comprising
an updating portion configured to update the first set time period based on a printing standby time period corresponding to a printing instruction for print data that has been newly received.

4. The image forming apparatus according to claim 1, wherein
the return portion cancels the power saving operation state and causes the image forming apparatus to return to the normal operation state when the printing instruction has been inputted before the counted value reaches the first set time period.

5. The image forming apparatus according to claim 1, further comprising
a power saving portion configured to shift the normal operation state to the power saving operation state when the counted value has become a second set time period which is longer than the first set time period.

6. The image forming apparatus according to claim 5, wherein
the second set time period is a value obtained by multiplying the first set time period by a previously defined coefficient.

7. The image forming apparatus according to claim 1, wherein
a plurality of the first set time periods are respectively set for terminal devices each being a transmission source of print data or pieces of identification information for identifying respective users who use the terminal devices, and
the return portion cancels the power saving operation state and causes the image forming apparatus to return to the normal operation state when the counted value has become the first set time period corresponding to a terminal device or identification information.

8. The image forming apparatus according to claim 1, wherein
the power saving operation state is a state in which an amount of heat generated by a heating portion is suppressed, the heating portion configured to heat a recording medium to a predetermined temperature during image forming, and
the return portion cancels suppressing the amount of heat generated by the heating portion and heats the recording medium to the predetermined temperature to cause the image forming apparatus to return the normal operation state.
